(19) United States
(12) Patent Application Publication
(10) Pub. No.: US 2009/0222367 A1
(43) Pub. Date: Sep. 3, 2009

(54) System and Method for the Activation and Use of a Temporary Financial Card

(75) Inventors: Lawrence Kevin Jenkins, Richmond, VA (US); Michael Ryan Croxton, Richmond, VA (US); Matthew T. Flournoy, Midlothian, VA (US); Marc G. Nystrom, Richmond, VA (US); Julianna S. Byrd, Centreville, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Capital One Financial Corporation, McLean, VA (US)

(21) Appl. No.: 12/039,305

(22) Filed: Feb. 28, 2008

(51) Int. Cl. G06Q 40/00; G06K 19/067

(52) U.S. Cl. 705/35

(57) ABSTRACT

Systems and methods for the activation and use of a temporary financial card are provided. A customer may cause a temporary financial card to be activated and associated with a value, and may give the card to a recipient who may use the temporary financial card to conduct financial transactions.

### FIELD OF THE INVENTION

The present invention relates to a system and method for activating and using a temporary financial card.

### BACKGROUND OF THE INVENTION

As financial institution customers become more adept at electronic banking and conducting financial transactions electronically, the use of paper checks is declining. However, customers may continue to use checks even though they are not preferred or are inconvenient, for lack of an alternative. For example, traditional checks are not easily converted to currency. Checks must be cashed at a bank or other institution, which typically require the recipient to have an account. Many businesses do not allow customers to cash checks or sign over checks in exchange for products or services. Additionally, the recipient must typically wait for a check to clear the customer's account before recovering money, a process which may take several days. And, the recipient is at a disadvantage as a check may be forged or the customer may not have sufficient funds in their account to cover the amount listed on the check. By the time the bank or the recipient discovers a problem with a check, the customer may be unreachable. The prevalence of gift cards highlights this trend towards electronic banking. Customers wish to give gift cards to recipients as gifts, or sometimes as a payment. Gift cards must generally be purchased at a point of sale or ordered, and may be only usable at a particular location or locations.

### SUMMARY OF THE INVENTION

Accordingly, various embodiments of the present invention may be directed to a method for activating and using a temporary financial card by providing a plurality of temporary financial cards to a customer, receiving customer instruction to activate one of the one or more temporary financial cards, and activating one of the one or more temporary financial cards in response to the customer instruction. Various embodiments may also include a temporary financial card which has a check portion and a temporary financial card portion. The temporary financial cards may also be detachably attached to a carrier medium, which may, for example, be a greeting card or a sheet of paper. The temporary card may also comprise an information storage area, and the information storage area may comprise a modifiable magnetic substance.

Various other embodiments of the present invention may be directed to a temporary financial card device, comprising a check portion and a temporary financial card portion detachably attached to the check portion. In various embodiments the temporary financial card device may be formed from a paper cellulose or a plastic material, or may be formed from another material. The temporary card device may also comprise an information storage area, and the information storage area may comprise a modifiable magnetic substance.

Various other embodiments of the present invention may be directed to a system for activating and assigning value to a temporary financial card, comprising a module to provide a plurality of temporary financial cards to a customer, a module to receive customer instruction to activate one of the one or more temporary financial cards, and a module to activate one of the one or more temporary financial cards in response to the customer instruction. Various embodiments may also include a temporary financial card which has a check portion and a temporary financial card portion. The temporary financial cards may also be detachably attached to a carrier medium, which may, for example, be a greeting card or a sheet of paper. The temporary card may also comprise an information storage area, and the information storage area may comprise a modifiable magnetic substance.

Other embodiments may also be considered.

### BRIEF DESCRIPTION OF THE DRAWINGS

The present invention, together with further objects and advantages, may best be understood by reference to the following description taken in conjunction with the accompanying drawings, in the several Figures of which like reference numerals identify like elements, and in which:

FIG. 1 is diagram depicting the front view of a plurality of temporary financial cards according to at least one embodiment of the disclosure;

FIG. 1a is a diagram depicting the reverse view of a temporary financial card shown in FIG. 1 according to at least one embodiment of the disclosure;

FIG. 2 is a diagram depicting a check with a detachable temporary financial card according to at least one embodiment of the disclosure;

FIG. 3 is a diagram depicting a sheet of paper with a detachable temporary financial card according to at least one embodiment of the disclosure;

FIG. 4 is a diagram of a greeting card with a detachable temporary financial card according to at least one embodiment of the disclosure;

FIG. 5 is a schematic diagram of an exemplary temporary financial card authentication and assignment system according to at least one embodiment of the disclosure; and

FIG. 6 is a flow chart representing an exemplary method of activating and using a temporary financial card according to at least one embodiment of the disclosure.

### DETAILED DESCRIPTION

The following description is intended to convey a thorough understanding of the embodiments described by providing a number of specific exemplary embodiments and details involving systems and methods for the activation and use of a temporary financial card. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A financial institution and system supporting a financial institution are used as examples for the disclosure; the disclosure is not intended to be limited to financial institutions only. Various embodiments may be used wherever customers wish to create temporary financial cards and associate money with the temporary financial cards.

According to various embodiments of the present disclosure, a system and method of providing a temporary financial card, activating the card, and associating the card with funds from a customer's account may utilize one or more temporary financial cards, which are given or sold to a customer. The temporary financial cards may take many forms, for example a releasably bound stack of temporary financial cards or temporary financial cards releasably attached to a larger product, such as a check, a sheet of paper, or a greeting card. The customer may utilize a system to activate one of the temporary financial cards in the customer's possession and may associate an amount of money from the customer's account or line of credit to the temporary financial card. The customer may then give the temporary financial card to a recipient, who may use the temporary financial card at, for example, merchants or banks or automatic teller machines, to use the value associated with the temporary financial card for goods or services, or to convert all or some of the value on the temporary financial card to currency. Temporary may indicate a single use of the temporary financial card, more than one use of the temporary financial card, where the temporary financial card may expire when the balance associated reaches zero, or a limited-time multiple use of the temporary financial card.

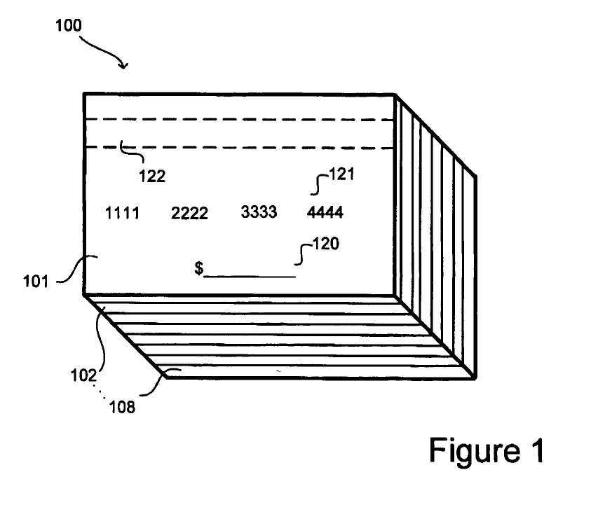

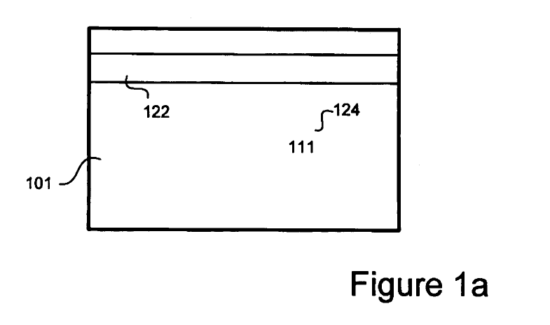

Turning to FIG. 1, a diagram 100 depicting the front view of a plurality of temporary financial cards 101-108 is shown according to at least one embodiment of the disclosure. According to various embodiments, temporary financial cards may be formed from a paper material, a plastic material, a metal material, or another material, and may be used one time or more than one time. The temporary financial cards may be stacked and removably bound. Also, the customer may receive the temporary financial cards unbound. A customer may receive the bundle of temporary financial cards from, for example, a financial institution where the customer has an account. The customer may also receive the bundle of temporary financial cards from a third party, for example a card printing or distribution company. The temporary financial cards may have a identification number 121, a writable area 120, and an information storage area 122 as describe din greater detail below.

Identification number 121 may be a sequence of letters and/or numbers which identify the individual temporary financial card 101. Identification number 121 may be unique to each temporary financial card 101, so that each temporary financial card has a different identification number. Also, the identification numbers may be recycled, so that after a temporary financial card 101 is used, the identification number 121 may be associated to a new, different temporary financial card 101. Identification number 121 may resemble the type of sequence used with credit cards or debit cards, for example, so that the temporary financial card 101 may have the appearance of a credit card or a debit card. Identification number 121 may be printed on to temporary financial card 101, or may be embossed upon temporary financial card 101, or may be conveyed on to temporary financial card 101 in other ways.

Writable area 120 may be an area of the temporary financial card 101 onto which ink, toner, or other media may be applied. As the example in FIG. 1 illustrates, writable area 120 may be used to indicate the amount of money that is initially associated with temporary financial card 101. Writable area 120 may also be used to convey a message or to convey terms and restrictions of temporary financial card 101. Also, writable area 120 may be used to indicate the recipient or the giver of temporary financial card 101.

FIG. 1a depicts the reverse view of a temporary financial card 101 shown in FIG. 1 according to at least one embodiment of the disclosure. The reverse of temporary financial card 101 may contain an information storage area 122 and a security code 124. Information storage area 122 and security code 124 may be located on the front of temporary financial card 101, and identification number 121 and writable area 120 may be located on the reverse of temporary financial card 101; the position of the elements on temporary financial card 101 is given as exemplary only.

Information storage area 122 may contain information readable by a scanner or reader. In one embodiment, information storage area 122 may comprise a magnetic area (e.g., a magnetic stripe) located on the reverse of temporary financial card 101. The magnetic area may be formed from a modifiable magnetic substance, such that the magnetic properties of the substance may be altered to store magnetically encoded information. The magnetic area may be encoded with information pertaining to temporary financial card 101. For example, and without limitation, the magnetic area may contain encoded information regarding identification number 121, or the name of the customer, or one or more security codes 124, or a personal identification number (“PIN”), or another code or sequence of characters that may identify temporary financial card 101 to a reader. Also, information storage area 122 may comprise a radio frequency identification device (“RFID”), which may be encoded with information regarding the identification number 121, or the name of the customer, or the security code, or another code or sequence of characters to identify the temporary financial card 101 to a reader. The information storage area 122 may also comprise characters readable by optical character recognition (“OCR”), a one-dimensional barcode, a two-dimensional barcode, or other optical encoding systems capable of reception and decoding by a reader or scanner.

One or more security codes 124 may appear on temporary financial card 101. One or more security codes 124 may differ from identification number 121. Temporary financial card 101 issuer may associate the one or more security codes 124 to identification number 121. The one or more security codes 124 may be used, for example, in a transaction where the physical card is not seen by the merchant, to provide assurances that the user of temporary financial card 101 has physical possession of temporary financial card 101.

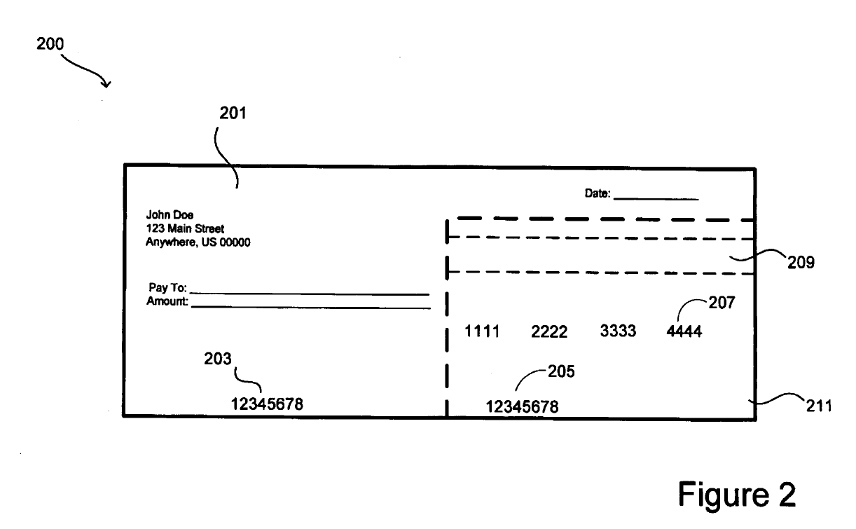

FIG. 2 depicts a check with a detachable temporary financial card 200 according to at least one embodiment of the disclosure. The check with detachable temporary financial card 200 may comprise a check portion 201 and a detachable temporary financial card portion 211. Check portion 201 may contain a writable surface area and may also contain a first portion of the customer's account information 203. Additionally, one or more of the checks with detachable temporary financial cards 200 may be releasably bound together, so that a customer may receive a bound series of the checks and may activate and use one of the checks at a time.

Detachable temporary financial card portion 211 may be releasable from check portion 201 and may also contain a writable surface area. Detachable temporary financial card portion 211 may also contain a second portion of the customer's account information 205, as well as an information storage area 209, an identification number 207, and one or more security numbers (not shown in FIG. 2).

Information storage area 209 may be present on the reverse of temporary financial card portion 211, and may contain information readable by a scanner or reader. In one embodiment, the information storage area 209 may comprise a magnetic area located on the reverse of the temporary financial card as described above. The magnetic area may be encoded with information pertaining to the temporary financial card portion 211. For example, and without limitation, the magnetic area may contain encoded information regarding the identification number 207, or the name of the customer, or one or more security codes, or a personal identification number (“PIN”), or another code or sequence of characters that may identify the temporary financial card to a reader. Information storage area 209 may also comprise a radio frequency identification device (“RFID”), which may be encoded with information regarding the identification number 207, or the name of the customer, or the security code, or another code or sequence of characters to identify the temporary financial card to a reader. Information storage area 209 may also comprise characters readable by optical character recognition (“OCR”), a one-dimensional barcode, a two-dimensional barcode, or other optical encoding systems capable of reception and decoding by a reader or scanner. Although information storage area 209 is illustrated as being on the reverse of temporary financial card portion 211, information storage area 209 may also appear on the front of temporary financial card portion 211. Identification number 207 may also appear on the reverse of temporary financial card portion 211.

One or more security codes may appear on the reverse of temporary financial card portion 211. The security codes may differ from identification number 207. The temporary financial card issuer may associate the one or more security codes to identification number 207. The one or more security codes may be used, for example, in a transaction where the physical card is not seen by the merchant, to provide assurances that the user of the temporary financial card has physical possession of the temporary financial card. The one or more security codes may also appear on the front of the temporary financial card portion 211.

Identification number 207 may be a sequence of letters and/or numbers which identify the individual temporary financial card portion 211. Identification number 207 may be similarly described as disclosed above.

The first portion of the customer's account identification 203 and the second portion of the customer's account identification 205 may be printed in a way as to allow automated processing as a bank draft or check. For example, the first portion of the customer's account identification 203 may comprise the bank routing codes displayed in a standard font as is known in the check processing industry. The second portion of the customer's account identification 205 may comprise the customer's account number at the bank represented by the bank routing codes in the first portion of the customer's account identification 203 displayed in a standard font as is known in the check processing industry. The two portions 203 and 205 of the customer's account identification may be combinable so as to allow the check with detachable temporary financial card 200 to be used as a standard check instrument. If temporary financial card portion 211 is detached from check portion 201, then the first portion of the customer's account identification 203 and the second portion of the customer's account identification 205 may be separated, so that the check with detachable temporary financial card 200 may not be able to be used as a standard check instrument. If temporary financial card portion 211 is not detached from check portion 201, and check with detachable temporary financial card 200 is used as a traditional check, then the amount associated with temporary financial card portion 211 may be reduced, so that temporary financial card portion 211 may not be used after the check with detachable temporary financial card 200 is submitted, for example, to a financial institution for payment.

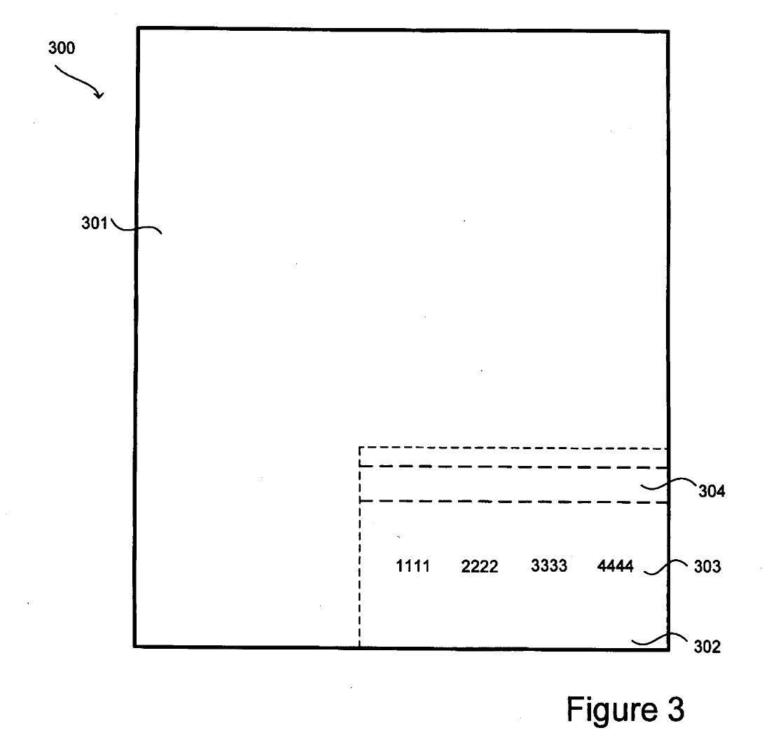

FIG. 3 depicts a sheet of paper with a detachable temporary financial card 300 according to at least one embodiment of the disclosure. The sheet of paper with detachable temporary financial card 300 may comprise a printable portion 301 and a detachable temporary financial card portion 302. Printable portion 301 may contain a writable surface area. Additionally, one or more of the sheets of paper with detachable temporary financial card portions 300 may be releasably bound together, so that a customer could receive a bound series of sheets and could activate and use one of the temporary financial cards at a time.

Detachable temporary financial card portion 302 may be releasable from printable portion 301 and may contain a writable surface area. Detachable temporary financial card portion 302 may also contain an information storage area 304, an identification number 303, and one or more security numbers, similar to the features described above.

Sheet of paper with a detachable temporary financial card 300 may be operable to be fed through a printer or typewriter, so that the sheet of paper may contain a writing or picture. For example, a customer may pay employees with the embodiment shown in FIG. 3. The customer may print or type pertinent information related to the payment, such as taxes withheld or the amount associated with the temporary financial card. For example, an employee may then receive the sheet of paper with the temporary financial card portion 300, may detach temporary financial card portion 302, and may proceed to use temporary financial card portion 302 to purchase goods or services.

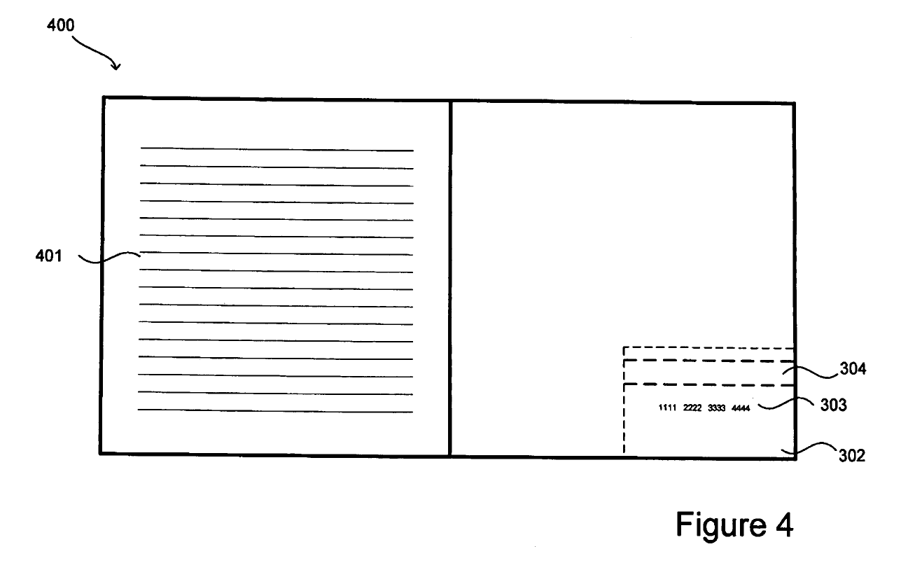

FIG. 4 depicts a greeting card with a detachable temporary financial card 400 according to at least one embodiment of the disclosure. The greeting card with detachable temporary financial card 400 may be purchased at, for example, a greeting card store or other convenience store, or may be ordered from a financial institution where the customer maintains an account. The greeting card with a detachable temporary financial card 400 may contain the same elements as the sheet of paper with a detachable temporary financial card 300, an exemplary embodiment of which is found in FIG. 3. The greeting card 400 may be of a different quality of paper than the printed sheet embodiment 300 found in FIG. 3, and may contain printed pictures or words 401.

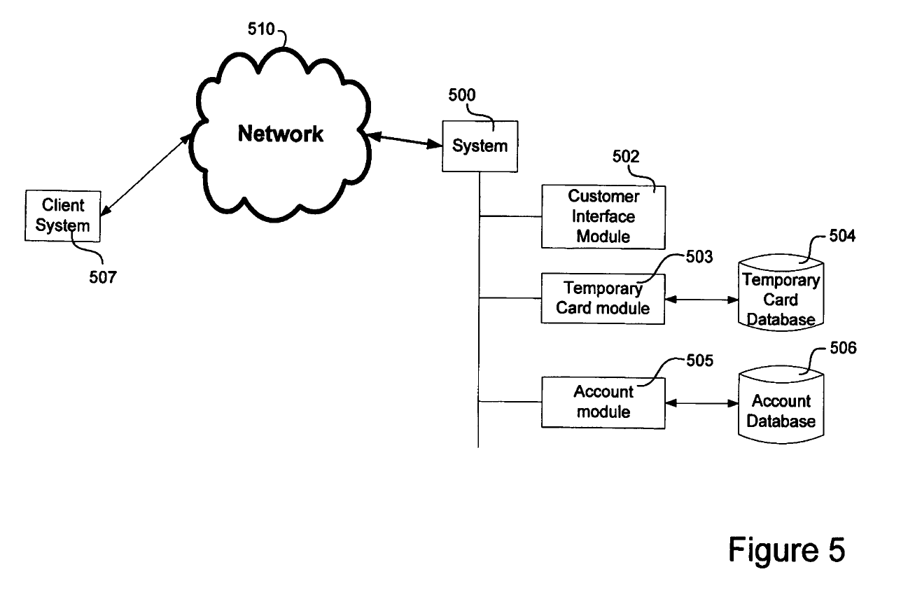

FIG. 5 depicts a schematic diagram of a temporary financial card authentication and assignment system 500 according to at least one embodiment of the disclosure. One embodiment of the disclosure may have a temporary financial card authentication and assignment system 500 in communication with a customer system 507 via network 510. Network 510 may include, but is not limited to: e.g., a wide area network (WAN), a local area network (LAN), a global network such as the Internet, a telephone network such as a public switch telephone network, a wireless communication network, a cellular network, an intranet, or the like, or any combination thereof. In exemplary embodiments of the disclosure, the network may include one, or any number of the exemplary types of networks mentioned above operating as a stand-alone network or in cooperation with each other. Use of the term network herein is not intended to limit the network to a single network. The user or customer may interact with temporary financial card authentication and assignment system 500 across network 510, or other mechanisms may be used to input temporary financial card information and activate one or more of the temporary financial cards.

Temporary financial card authentication and assignment system 500 may be generally operable to store and present authentication and assignment data to the financial institution and/or the customer. Authentication and assignment data may include, but is not limited to, account information, temporary financial card identification numbers, PIN numbers, security codes related to temporary financial cards, customer financial information, or any other kind of data kept by an institution about or for customers. Temporary financial card authentication and assignment system 500 may contain one or more of the following modules: a customer interface module 502, a temporary financial card module 503, and an account module 505. Although not specifically illustrated in FIG. 5, temporary financial card authentication and assignment system 500 may also have other modules to store and process customer account information. As shown in FIG. 5, customer interface module 502, temporary card module 503, and account module 505 may communicate with some or all of the modules. The modules of temporary financial card authentication and assignment system 500 may be part of a single system, or the modules may be physically or logically separated. Temporary financial card authentication and assignment system 500 may be operably connected to network 510 so that the modules of temporary financial card authentication and assignment system 500 are able to receive signals from network 510 and generate signals to be provided to network 510.

Customer interface module 502 may include a mechanism for customer authentication. For example, and without limitation, the mechanism for customer authentication may comprise a password that the customer inputs into the customer system 507, and/or the mechanism may be a biometric identification device the customer utilizes to authenticate, such as the customer's hand, fingerprint, gait, voice, iris, face, or other recognizable feature substantially unique to the customer. Customer interface module 502 may receive authentication information (e.g., as signals from network 510), and may attempt to match the authentication information to a record of an existing customer. In an exemplary embodiment, the authentication information may be received as encrypted ciphertext and decrypted according to protocols known in the art. If the authentication information matches identification information of a customer in customer interface module 502, then the customer may be allowed to proceed. If the authentication information does not match identification information of a customer in the system, the customer may not be not allowed to proceed.

Account module 505 may contain a plurality of account information related to one or more customers. Account module 505 may also be in communication with an account database 506. Account database 506 may be operable to store and recall information related to one or more customer's accounts. For example, account database 506 may be operable to store and recall information related to a customer's transactions, the customer's current balance or current remaining credit, other relevant customer information. Account module 505 may be operable to query account database 506 and present the information from account database 506 to other modules in temporary financial card authentication and assignment system 500. While account database 506 has been described as a database, it should be appreciated by one of ordinary skill in the art that account database 506 may store and recall account information by a number of different methods. For example, account database 506 could be a single electronic file, or multiple electronic files, or a spreadsheet. Account database 506 may also be a relational database or any other form of data storage.

temporary card module 503 may include information related to one or more temporary cards, such as activation status, PIN number association, or amount associated with the temporary financial card. The temporary card module 503 may also be in communication with a temporary account database 504. Temporary card database 504 may be operable to store and recall information related to one or more temporary financial cards. For example, temporary card database 504 may be operable to store and recall information related to transactions associated with one or more of the temporary cards, activation status of one or more temporary financial cards, or the amount initially associated with or amount currently associated with one or more temporary financial cards. Temporary card module 503 may be operable to query temporary card database 504 and present the information from temporary card database 504 to other modules in temporary financial card authentication and assignment system 500. While temporary card database 504 has been described as a database, it should be appreciated by one of ordinary skill in the art that temporary card database 504 may store and recall information related to one or more temporary cards by a number of different methods. For example, temporary card database 504 could be a single electronic file, or multiple electronic files, or a spreadsheet. Temporary card database 504 may also be a relational database or any other form of data storage.

The customer may operate a customer system 507 to interface with the temporary financial card authentication and assignment system 500. The customer system 507 may be in communication with the temporary financial card authentication and assignment system 500 via a network 510. A customer system 507 may include, but is not limited to: e.g., any computer device, or communications device including, e.g., a personal computer (PC), a workstation, a mobile device, a phone, a handheld PC, a personal digital assistant (PDA), a thin system, a fat system, an network appliance, an Internet browser, a paging, an alert device, a television, an interactive television, a receiver, a tuner, a high definition (HD) television, an HD receiver, a video-on-demand (VOD) system, a server, or other device. In one embodiment, the customer system 507 may contain an interface to view information received from exemplary temporary financial card authentication and assignment system 500 over network 510.

Though not depicted in FIG. 5, those of ordinary skill in the art will appreciate that a plurality of potential customer systems may be used by the customer to interact with the temporary financial card authentication and assignment system. For example, if the network comprises the Internet, the customer system may interact with the temporary financial card authentication and assignment system to view information and input preferences via a web browser client installed on the customer's system, such as INTERNET EXPLORER, NAVIGATOR, or FIREFOX web browser programs, offered by Microsoft Corporation of Redmond, Wash., Time Warner of New York, N.Y., and the Mozilla Foundation of Mountain View, Calif., respectively. Those of ordinary skill in the art will appreciate that computer systems may include traditional desktop and laptop computer systems as well as Personal Digital Assistants (PDAs), mobile phones, BLACKBERRY devices, and other portable communication devices. These devices all typically include some form of browser client that enables a person to view content delivered across the Internet. Web browser programs may include HTTP browsers, as well as Wireless Application Protocol (WAP) browsers, or any other suitable browser based on currently known or previously un-standardized Internet protocols.

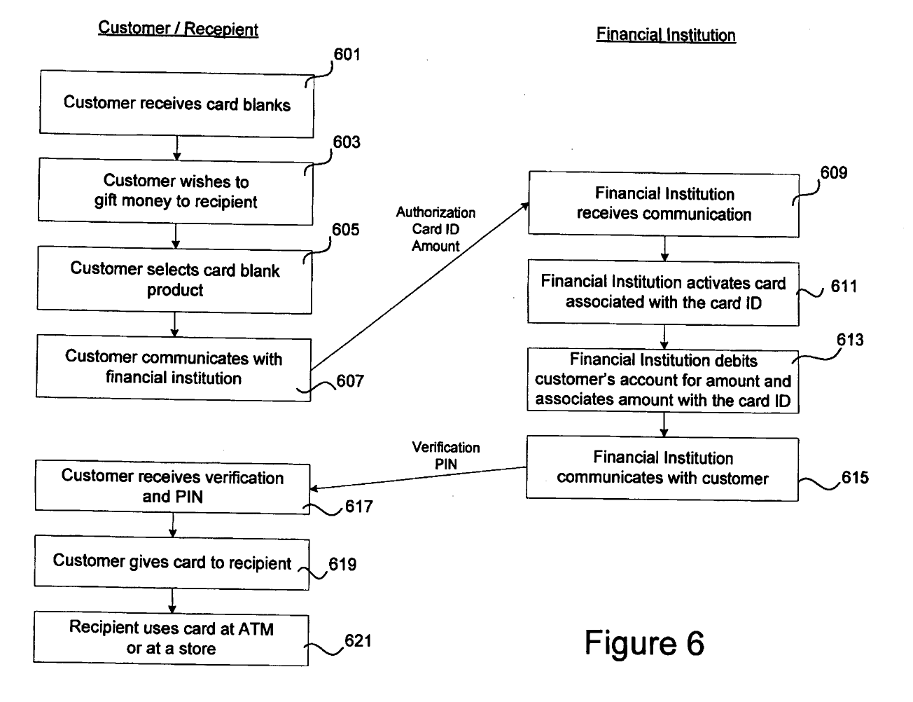

FIG. 6 depicts a flow chart representing an exemplary method of activating and using a temporary financial card according to at least one embodiment of the disclosure. In box 601, the customer may receive one or more temporary financial card blanks. As noted above, the customer may receive the temporary financial card blanks from a financial institution or may receive them from a third party, such as a printing company, a greeting card store, or a convenience store, or any other place that temporary financial cards may be created and/or sold. The financial institution may be, for example, one or more companies in which the customer has a financial relationship. The customer may, for example, have a savings or checking account at the financial institution, or may have a line of credit through a loan or a credit card. The customer may wish to gift money to a recipient, and/or wish to activate and add value to a temporary financial card for another purpose. In block 605, the customer may select one of the one or more temporary financial cards that the customer has been provided or has purchased. Upon selecting a temporary financial card, the customer may interact with the financial institution, in block 607, to activate and add value to the temporary financial card. In one exemplary embodiment, the customer may visit a website, for example, to activate the temporary financial card. Also, the customer may use a telephone or other voice transmission device to speak with a customer service representative of the financial institution and/or an automated system to activate and add value to the temporary financial card. The customer may transmit identification information, an identifier identifying the temporary financial card, and an amount that the customer wishes to transfer to the temporary financial card. The financial institution may retain identification information related to the temporary financial cards that the customer received from the financial institution. In such an embodiment, the customer may not be required to transmit the identification information related to the temporary financial card.

In block 609, the financial institution may receive the information that the customer has transmitted to the financial institution. The financial institution may utilize the information transmitted by the customer to activate the temporary financial card that the customer has selected to use. The identification information may be associated with an active state in the financial institution's system, or the identification information may be associated with the temporary financial card's identification information at the financial institution, so that the customer need not transmit the temporary financial card's actual identification information directly over the network. In block 613, the financial institution may analyze the customer's account to ensure that the customer has funds or a credit line which is greater or equal to the amount that the customer has requested to be associated with the temporary financial card. If the customer's funds or credit line are less than the amount that the customer has requested to be associated with the temporary financial card, the financial system may deny the customer's request, or may prompt the customer to enter a different amount to be associated with the temporary financial card. If the customer's funds or credit link are greater or equal to the amount that the customer has requested, then the financial institution may associate that amount with the temporary financial card's identification information in the financial institution's system. The amount may then be removed from the customer's account or line of credit. Also, the temporary financial cards that the customer receives may be pre-activated, so that the customer may need to transmit an amount to associate with the temporary financial card.

In block 615, the financial institution may then communicate information to the customer. The communication may be in the form of a denial or a prompt to add funds or reduce the amount requested to be associated with the temporary financial card, if the customer's account or line of credit is not compatible with the amount the customer has requested to associate with the temporary financial card, or the financial institution may transmit verification information to the customer if the temporary financial card has been associated with the amount that the customer requested. The financial institution may also transmit a PIN number, to be used with the temporary financial card. In an alternate embodiment, a PIN number is associated with the temporary financial card before the customer requests activation of the temporary financial card.

In block 617, the customer may receive verification information from the financial institution, and may also receive a PIN number for the temporary financial card. In block 619, the customer may then give the activated card to the recipient, along with the PIN number. In block 621, the recipient may use the temporary financial card at merchants, which may access the financial institution system to deduct money from the temporary financial card in exchange for goods or services. Or, the recipient may use the temporary financial card and PIN number at a bank or automatic teller machine to remove currency.

Although not depicted in FIG. 6, if the temporary financial card is lost or stolen, then the customer and/or the recipient may contact the financial institution. The financial institution may deactivate the temporary financial card and may associate the remaining value or another value with a new temporary financial card. The new temporary financial card may be used in place of the lost or stolen temporary financial card by the customer and/or the recipient.

Various embodiments of the present disclosure may encourage customers to give temporary financial cards to recipients, and thus avoid the use of paper checks, which may be inefficient. The customer may easily associate funds from the customer's account onto a temporary financial card in a way as to allow the recipient to use the card almost immediately at a variety of merchants. The recipient may also choose to withdraw the funds associated with the temporary financial card as currency.

The exemplary embodiments described herein are not to be limited in scope. For example, these embodiments need not be used by a financial institution. It is within the scope of the invention that the invention be used wherever temporary financial cards may be used or provided to customers. Thus, such modifications are intended to fall within the scope of the following appended claims. Further, although some of the embodiments have been described herein in the context of a particular implementation in a particular environment for a particular purpose, those of ordinary skill in the art should recognize that its usefulness is not limited thereto and that the embodiments of the present inventions can be beneficially implemented in any number of environments for any number of purposes. Accordingly, the claims set forth below should be construed in view of the full breadth and spirit of the embodiments of the present inventions as disclosed herein. While the foregoing description includes many details and specificities, it is to be understood that these have been included for purposes of explanation only, and are not to be interpreted as limitations of the invention. Many modifications to the embodiments described above can be made without departing from the spirit and scope of the invention.

What is claimed is:

1. A method comprising:
providing one or more temporary financial cards to a customer, the one or more temporary financial cards associated with one or more customer accounts;
receiving customer instruction to activate one of the one or more temporary financial cards; and
activating one of the one or more temporary financial cards in response to the customer instruction.

2. The method according to claim 1, where the temporary financial cards have a check portion and a temporary financial card portion.

3. The method according to claim 1, where the temporary financial cards are detachably attached to a carrier medium.

4. The method according to claim 3, where the carrier medium is a greeting card.

5. The method according to claim 3, where the carrier medium is a sheet of paper.

6. A method according to claim 1, where the temporary financial card portion contains an information storage area.

7. A method according to claim 6, where the information storage area comprises a modifiable magnetic substance.

8. A temporary financial card device, comprising
a check portion,
a temporary financial card portion detachably attached to the check portion.

9. A temporary financial card device according to claim 8, where the temporary financial card portion is formed from a cellulose material.

10. A temporary financial card device according to claim 8, where the temporary financial card portion is formed from a plastic material.

11. A temporary card device according to claim 8, where the temporary financial card portion contains an information storage area.

12. A temporary card device according to claim 11, where the information storage area comprises a modifiable magnetic substance.

13. A system for activating and assigning value to a temporary financial card, comprising:
a module to provide a plurality of temporary financial cards to a customer, the one or more temporary financial cards associated with one or more customer accounts;
a module to receive customer instruction to activate one of the one or more temporary financial cards; and
a module to activate one of the one or more temporary financial cards in response to the customer instruction.

14. The system according to claim 13, where the temporary financial cards have a check portion and a temporary financial card portion.

15. The system according to claim 13, where the temporary financial cards are detachably attached to a carrier medium.

16. The system according to claim 15, where the carrier medium is a greeting card.

17. The system according to claim 15, where the carrier medium is a sheet of paper.

18. A system according to claim 13, where the temporary financial card contains an information storage area.

19. A system according to claim 18, where the information storage area comprises a modifiable magnetic substance.
